(19) United States
(12) Patent Application Publication
(10) Pub. No.: US 2011/0128287 A1
(43) Pub. Date: Jun. 2, 2011

(54) METHOD OF DISPLAYING STEREOSCOPIC IMAGE AND DISPLAY APPARATUS FOR PERFORMING THE SAME

(76) Inventors: Hyo-Chul Lee, Uijeongbu-si (KR); Choong-Yull Kwak, Seoul (KR); Kyu-Hun Lim, Buyeo-gun (KR); Jin-Man Yun, Seongnam-si (KR)

(21) Appl. No.: 12/778,512

(22) Filed: May 12, 2010

(30) Foreign Application Priority Data
Nov. 27, 2009 (KR) 2009-0115466

(51) Int. Cl. G06T 15/50

(52) U.S. Cl. 345/426

(57) ABSTRACT

A method of displaying a stereoscopic image includes providing light to a first display area of a display panel during a second sub frame of an (N−1)-th frame, the first display area displaying a first left eye image during a first sub frame of the (N−1)-th frame prior to the second sub frame of the (N−1)-th frame panel and providing the light to a second display area of the display panel during a first sub frame of an N-th frame, the second display area displaying a second left eye image during the second sub frame of the (N−1)-th frame prior to the first sub frame of the N-th frame, where N is positive integer.

### CROSS-REFERENCE TO RELATED APPLICATIONS

This application claims priority under 35 U.S.C. §119 to Korean Patent Application No. 2009-115466, filed on Nov. 27, 2009 in the Korean Intellectual Property Office (KIPO), the disclosure of which is incorporated by reference in its entirety herein.

### BACKGROUND

1. Technical Field

Exemplary embodiments of the present invention relate to a method of displaying stereoscopic image and a display apparatus for performing the method, and more particularly to a method of displaying stereoscopic images using a shutter stereoscopic type and a display apparatus for performing the method.

2. Discussion of Related Art

A stereoscopic image display apparatus displays a three-dimensional (3D) stereoscopic image, which can be used in various applications such as games, movies, etc. The stereoscopic image display apparatus applies 2D flat images that are different from each other to each eye to display the 3D stereoscopic image. For example, a pair of 2D flat images viewed by each eye may be synthesized and interpreted by the brain t as a 3D stereoscopic image.

A 3D image from a stereoscopic image display device can be perceived by two eyes of a human using a principle known as binocular parallax. For example, since the two eyes of a human are spaced apart from each other, images viewed at the different angles are input to the brain of human. Thus, an observer may perceive a 3D image from a collection of 2D images.

Stereoscopic image display devices may be classified into a stereoscopic type with an extra spectacle and an auto-stereoscopic type without the extra spectacle. The stereoscopic type may include an anaglyph type, a liquid crystal shutter stereoscopic type, etc. In the anaglyph type, a viewer wears a pair of glasses fitted with one blue lens and one red lens. In the liquid crystal shutter stereoscopic type, the viewer wears a pair of glasses which sequentially open or close a left eye liquid crystal shutter and a right eye liquid crystal shutter in synchronization with the period of the left and right eye frame images.

The shutter stereoscopic type opens the left eye shutter or the right eye shutter during a vertical blanking period of one frame after the left eye frame image or the right eye frame image is displayed on the display panel during an active period of one frame. The vertical blanking period of one frame may be increased by about 30% of one frame to increase a viewing period. The active period is decreased when the vertical blanking period is increased, thereby increasing a driving frequency for displaying the image on the display panel. However, it may be difficult to drive the display panel when the driving frequency has been increased.

### SUMMARY OF THE INVENTION

According to an exemplary embodiment of the present invention, a method of displaying a stereoscopic image includes providing light to a first display area of a display panel during a second sub frame of an (N−1)-th frame, and the first display area displaying a first left eye image during a first sub frame of the (N−1)-th frame prior to the second sub frame of the (N−1)-th frame panel, providing light to a second display area of the display panel during a first sub frame of an N-th frame, and the second display area displaying a second left eye image during the second sub frame of the (N−1)-th frame prior to the first sub frame of the N-th frame, providing light to the first display area of the display panel during a second sub frame of the N-th frame, and the first display area displaying a first right eye image during the first sub frame of the N-th frame prior to the second sub frame of the N-th frame, providing light to the second display area of the display panel during a first sub frame of an (N+1)-th frame, and the second display area displaying a second right eye image during the second sub frame of the N-th frame prior to the first sub frame of the (N+1)-th frame (e.g., N is a positive integer).

According to an exemplary embodiment of the present invention, a method of displaying a stereoscopic image includes displaying a first left eye image on a first display area of a display panel and displaying a second left eye image on a second display area of the display panel during a first sub period within a reference active period of an (N−1)-th main vertically synchronized signal., maintaining displaying of the first and second left images on the display panel during a second sub period within the reference active period of the (N−1)-th main vertically synchronized signal, displaying a first right eye image on the first display area and a second right eye image on the second display area during a first sub period within a reference active period of an N-th main vertically synchronized signal, and maintaining display of the first and second right images displayed on the display panel during a second sub period within the reference active period of the N-th main vertically synchronized signal.

According to an exemplary embodiment of the present invention, a display apparatus includes a display panel, a light source module and a shutter device. The display panel periodically displays a left eye frame image and a right eye frame image. The light source module includes a first light-emitting block and a second light-emitting block, the first light-emitting block provides light to a first display area of the display panel when a first left eye image or a first right eye image is displayed on the first display area, the second light-emitting block provides the light to a second display area of the display panel when a second left eye image or a second right eye image is displayed on the second display area. The shutter device (e.g., glass) includes a first shutter and a second shutter, and the first shutter is open when the left eye frame image is displayed on the display panel, and the second shutter is open when the right eye frame image is displayed on the display panel.

According to an exemplary embodiment of the present invention, a display apparatus includes a display panel, a first data driving part, a second data driving part and a shutter device (e.g., glass). The display panel periodically displays a left eye frame image and a right eye frame image. The first data driving part provides a first left eye image or a first right eye image to a first display area of the display panel during a first sub period within a reference active period of a main vertically synchronized signal. The second data driving part provides a second left eye image or a second right eye image to a second display area of the display panel during the first sub period. The shutter device includes a first shutter and a second shutter, and selectively opens the first shutter and the second shutter according to the left eye fame image or the right eye fame image displayed on the display panel during a second sub period within the reference active period.

### BRIEF DESCRIPTION OF THE DRAWINGS

The present invention will become more apparent by describing in detailed exemplary embodiments thereof with reference to the accompanying drawings, in which:

FIG. 1 is a block diagram illustrating a display apparatus according to an exemplary embodiment of the present invention;

FIGS. 2A and 2B are schematic diagrams showing a method of driving a light source module of FIG. 1 according to an exemplary embodiment of the present invention;

FIGS. 3A to 3C are schematic diagrams showing exemplary embodiments of the light source module of FIG. 1;

FIG. 4 is a timing diagram illustrating a method of displaying a stereoscopic image using the display apparatus of FIG. 1 according an exemplary embodiment of the invention;

FIG. 5 is schematic diagram illustrating a method of displaying the stereoscopic image using the display apparatus of FIG. 1 according to an exemplary embodiment of the invention;

FIG. 6 is a block diagram illustrating a display apparatus according to an exemplary embodiment of the present invention; and

FIG. 7 is a timing diagram illustrating a method of displaying a stereoscopic image using the display apparatus of FIG. 6 according to an exemplary embodiment of the invention.

### DETAILED DESCRIPTION OF EXEMPLARY EMBODIMENTS

The present invention is described more fully hereinafter with reference to the accompanying drawings, in which exemplary embodiments of the present invention are shown. The present invention may, however, be embodied in many different forms and should not be construed as limited to the exemplary embodiments set forth herein. It will be understood that when an element or layer is referred to as being “on,” “connected to” or “coupled to” another element or layer, it can be directly on, connected or coupled to the other element or layer or intervening elements or layers may be present. Like numerals refer to like elements throughout. Hereinafter, exemplary embodiments the present invention will be explained in detail with reference to the accompanying drawings.

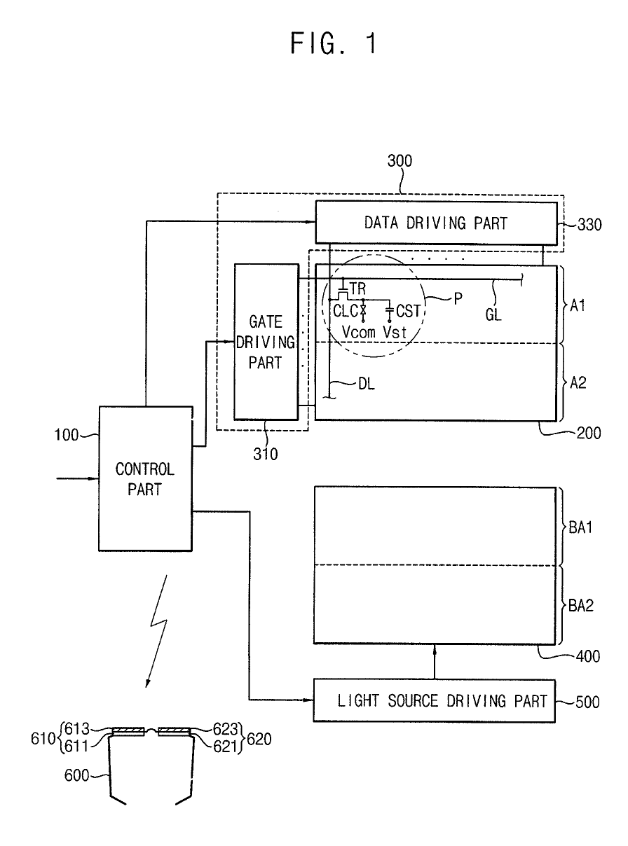

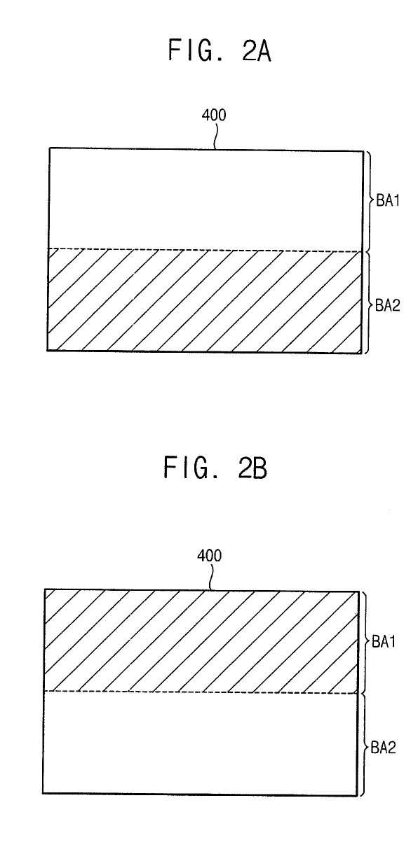

FIG. 1 is a block diagram illustrating a display apparatus according to an exemplary embodiment of the present invention. FIGS. 2A and 2B are schematic diagrams showing a method of driving a light source module of FIG. 1 according to an exemplary embodiment of the present invention.

Referring to FIG. 1, the display apparatus includes a control part 100, a display panel 200, a panel driving part 300, a light source module 400, a light source driving part 500 and a shutter device 600. For example, the shutter device may be made of a transparent or translucent material such as glass, plastic, etc.

The control part 100 controls an operation of the display apparatus based on a synchronized signal. The control part 100 provides a left eye image and a right eye image to the panel driving part 300 based on the synchronized signal and an image signal. The synchronized signal and the image signal may be provided from an external source. The control part 100 controls the light source driving part 500 based on an image displayed on the display panel 200 to emit light from the light source module 400. The control part 100 controls the shutter device 600 based on the image displayed on the display panel 200. The shutter device 600 may be positioned between the light source module 400 and the display panel 200.

The display panel 200 includes a plurality of pixels corresponding to an image resolution and displays a frame image thereon. Each of the pixels P includes a switching element TR connected to a data line DL and a gate line GL, a liquid crystal capacitor CLC connected to the switching element TR and a storage capacitor CST connected to the switching element TR. The data line DL and the gate line may cross one another. A common voltage VCOM is applied to the liquid crystal capacitor CLC and a storage voltage VST is applied to the storage capacitor CST.

The panel driving part 300 includes a gate driving part 310 providing a gate signal to the gate line GL and a data driving part 330 providing a data voltage to the data line DL.

The light source module 400 provides light to the display panel 200. The light source module 400 includes a first light-emitting block BA1 providing the light to a first display area A1 of the display panel 200 and a second light-emitting block BA2 providing the light to a second display area A2 of the display panel 200. For example, referring to FIGS. 2A and 2B, the first light-emitting block BA1 emits the light and the second light-emitting block BA2 is turned off during a first sub frame of one frame. The first light-emitting block BA1 is turned off and the second light-emitting block BA2 emits the light during a second sub frame of the one frame.

The light source driving part 500 controls an operation of each of the first and second light-emitting blocks BA1 and BA2. For example, when an image displayed on the first display area A1 of the display panel 200 changes from the left eye image to the right eye image or from the right eye image to the left eye image, the light source driving part 500 controls the first light-emitting block BA1 to turn off the first light-emitting block BA1. When one of the left eye image and the right eye image is displayed on the second display area A2 of the display panel 200, the light source driving part 500 controls the second light-emitting block BA2 corresponding to the display area A2 to emit the light. However, when an image displayed on the second display area A2 of the display panel 200 changes from the left eye image into the right eye image or from the right eye image into the left eye image, the light source driving part 500 controls the second light-emitting block BA2 to turn off the second light-emitting block BA2. When one of the left eye image and the right eye image is displayed on the first display area A1 of the display panel 200, the light source driving part 500 controls the first light-emitting block BA1 corresponding to the first display area A1 to emit the light.

The shutter device 600 includes a left eye lens part 610 and a right eye lens part 620. The left eye lens part 610 includes a first lens 611 and a first shutter 613, and the right eye lens part 620 includes a second lens 621 and a second shutter 623. The shutter device 600 may be a liquid crystal (LC) shutter glass including an LC shutter that opens or closes in accordance with an arrangement angle of the LC. The shutter device 600 opens the first shutter 613 and closes the second shutter 623 when the left eye image is displayed on the display panel 200. The shutter device 600 opens the second shutter 623 and closes the first shutter 613 when the right eye image is displayed on the display panel 200.

For example, when the first left eye image has been displayed on the first display area A1, the first light-emitting block BA1 emits the light and the first shutter 613 opens during a half of an N-th frame so that the first left eye image displayed on the first display area A1 may be viewed (wherein, ‘N’ is a positive integer). Then, when the second left eye image is displayed on the second display area A2, the second light-emitting block BA2 emits the light and the second shutter 623 opens during a half of the N-th frame so that the second left eye image displayed on the first display area A1 may be viewed.

As a result, the left eye frame image displayed on the display panel 200 may be viewed during the N-th frame. Using the same method, the right eye frame image displayed on the display panel 200 may be viewed during an (N+1)-th frame.

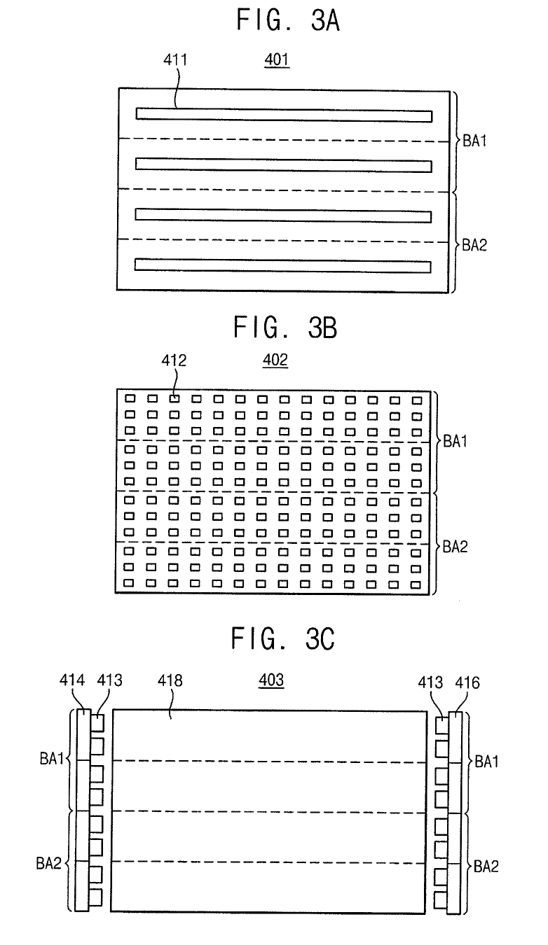

FIGS. 3A to 3C are schematic diagrams showing exemplary embodiments of the light source module of FIG. 1. Referring to FIGS. 1 and 3A, the light source module 401 includes a plurality of lamps. In at least one exemplary embodiment of a light source module 401 of FIG. 3A, each of the first and second light-emitting blocks BA1 and BA2 includes at least one lamp 411.

Referring to FIGS. 1 and 3B, the light source module 402 includes a plurality of light-emitting diodes (LEDs). In at least one exemplary embodiment of a light source module 402 of FIG. 3B, each of the first and second light-emitting blocks BA1 and BA2 includes a plurality of LEDs 412. The LEDs 412 may be arranged in a matrix of rows and columns.

Referring to FIGS. 1 and 3C, the light source module 403 includes a light guide plate (LGP) 418 and at least one edge light-emitting module. At least one edge light-emitting module is disposed adjacent to an edge of the LGP 418. For example, a first edge light-emitting module 414 is disposed adjacent to a first edge of the LGP 418, and includes a plurality of LEDs 413. A second edge light-emitting module 416 is disposed adjacent to a second edge opposite to the first edge of the LGP 418 and includes a plurality of LEDs 413.

The first edge light-emitting module 414 includes a first light-emitting block BA1 and a second light-emitting block BA2. The second light-emitting module 416 includes a third light-emitting block BA3 opposite to the first light-emitting block BA1 and a fourth light-emitting block BA4 opposite to the second light-emitting block BA2. The first and third light-emitting blocks BA1 and BA3 facing each other are driven in a synchronized driving timing, and the second and fourth light-emitting blocks BA2 and BA4 facing each other are driven in a synchronized driving timing.

In an alternate embodiment, although not shown in FIG. 3C, the light source module 403 may include only a single edge light-emitting module of the first and second edge light-emitting modules 414 and 416.

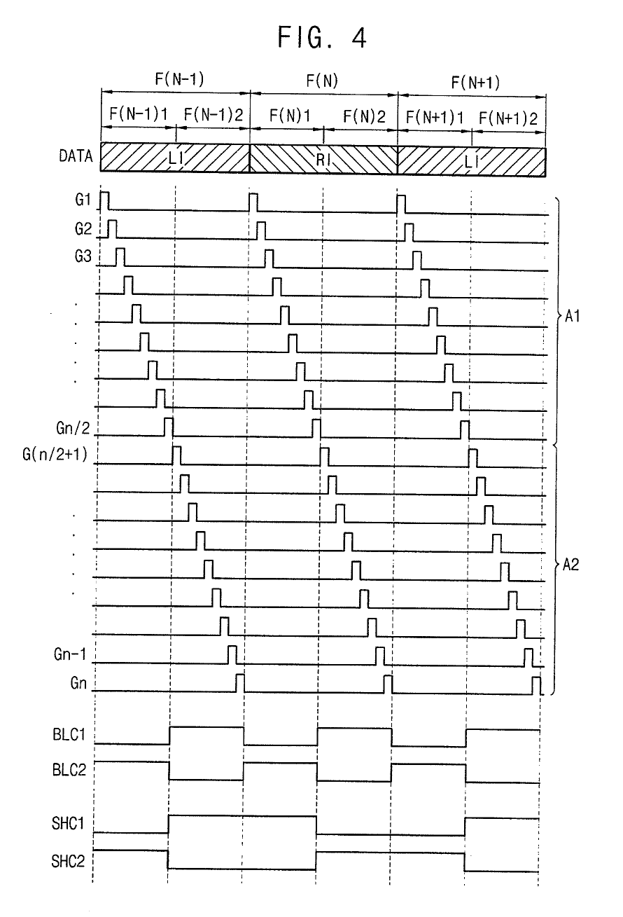

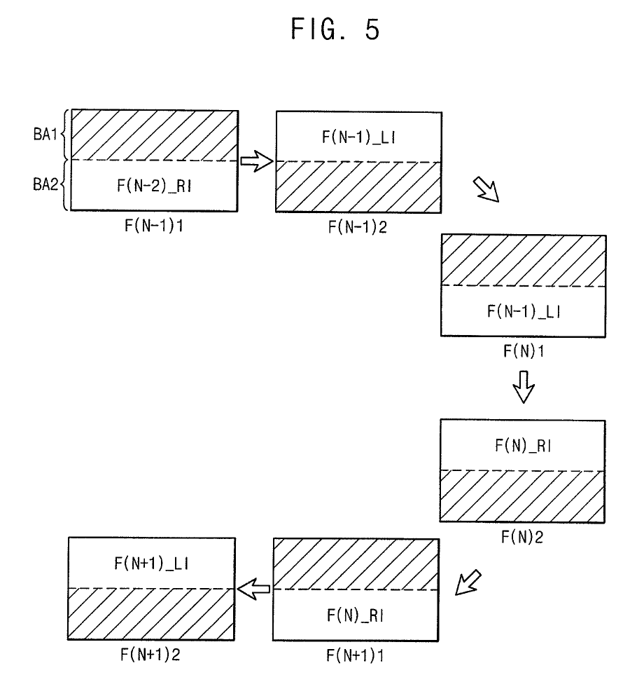

FIG. 4 is a timing diagram illustrating a method of displaying a stereoscopic image using the display apparatus of FIG. 1 according to an exemplary embodiment of the invention. FIG. 5 is schematic diagram illustrating a method of displaying the stereoscopic image using the display apparatus of FIG. 1 according to an exemplary embodiment of the invention.

Referring to FIGS. 1, 4 and 5, during an (N−1)-th frame F(N−1), the data driving part 330 provides an image data corresponding to the left eye image to a plurality of data lines of the display panel 200. The gate driving part 310 generates a plurality of gate signals and sequentially outputs the gate signals to a plurality of gate lines.

For example, the gate driving part 310 generates first to n-th gate signals G1, . . . , Gn and sequentially outputs the first to n-th gate signals G1, . . . , Gn to first to n-th gate lines of the display panel 200 (wherein, ‘n’ is a positive integer). The first to (n/2) gate lines are disposed on the first display area A1 of the display panel 200. When the first to (n/2)-th gate signals G1, . . . , Gn/2 are applied to the first to (n/2) gate lines, the first display area A1 displays an image. Additionally, the ((n/2)+1)-th to n-th gate lines are disposed on the second display area A2 of the display panel 200. When the ((n/2)+1)-th to n-th gate signals (G(n/2)+1, . . . , Gn) are applied to the ((n/2)+1)-th to n-th gate lines, the second display area A2 displays an image.

During a first sub frame F(N−1)1 of the (N−1)-th frame, the first to (n/2)-th gate signals G1, . . . , Gn/2 are applied to the first display area A1. Therefore, the first display area A1 displays an image that changes from a right eye image corresponding to the (N−2)-th frame F(N−2) into a left eye image corresponding to the (N−1)-th frame F(N−1). At this time, the second display area A2 displays a right eye image F(N−2)_RI corresponding to the (N−2)-th frame.

The first light-emitting block BA1 is turned off in response to a first light-emitting control signal BLC1 having a low level, and the second light-emitting block BA2 emits the light in response to a second light-emitting control signal BLC2 having a high level.

The shutter device 600 closes the first shutter 613 in response to a first shutter control signal SHC1 having a low level, and opens the second shutter 623 in response to a second shutter control signal SHC2 having a high level. Therefore, the viewer may view a second right eye image F(N−2)_RI corresponding to the (N−2)-th frame displayed on the second display area A2. However, the viewer may not view the image, which changes from a right eye image corresponding to the (N−2)-th frame F(N−2) into a left eye image corresponding to the (N−1)-th frame F(N−1), displayed on the first display area A1 since the first light-emitting block BA1 is turned off.

Then, during a second sub frame F(N−1)2 of the (N−1)-th frame, the ((n/2)+1)-th to n-th gate signals G(n/2)+1, . . . , Gn are applied to the second display area A2 of the display panel 200. Therefore, the second display area A2 displays an image that changes from a right eye image corresponding to the (N−2)-th frame F(N−2) into a left eye image corresponding to the (N−1)-th frame F(N−1). At this time, the first display area A1 displays a left eye image F(N−1)_LI corresponding to the (N−1)-th frame.

The first light-emitting block BA1 emits the light in response to the first light-emitting control signal BLC1 having the high level, and the second light-emitting block BA2 is turned off in response to the second light-emitting control signal BLC2 having the low level.

The shutter device 600 opens the first shutter 613 in response to the first shutter control signal SHC1 having the high level, and closes the second shutter 623 in response to the second shutter control signal SHC2 having the low level. Therefore, the viewer may view a first left eye image F(N−1)_LI corresponding to the (N−1)-th frame displayed on the first display area A1 of the display panel 200. However, the viewer may not view the image, which changes from a right eye image corresponding to the (N−2)-th frame F(N−2) into a left eye image corresponding to the (N−1)-th frame F(N−1), displayed on the second display area A2 since the second light-emitting block BA2 is turned off.

During a first sub frame F(N)1 of the N-th frame, the first to the (n/2)-th gate signals G1, . . . , Gn/2 are applied to the first display area A1. Therefore, the first display area A1 displays an image that changes from a left eye image corresponding to the (N−1)-th frame F(N−1) into a right eye image corresponding to the N-th frame F(N). At this time, the second display area A2 displays a left eye image F(N−1)_LI corresponding to the (N−1)-th frame.

The first light-emitting block BA1 is turned off in response to the first light-emitting control signal BLC1 having the low level, and the second light-emitting block BA2 emits the light in response to the second light-emitting control signal BLC2 having the high level.

The shutter device 600 opens the first shutter 613 in response to the first shutter control signal SHC1 having the high level, and closes the second shutter 623 in response to the second shutter control signal SHC2 having the low level. Therefore, the viewer may view a second left eye image F(N−1)_LI corresponding to the (N−1)-th frame displayed on the second display area A2. However, the viewer may not view the image, which changes from a left eye image corresponding to the (N−1)-th frame F(N−1) into a right eye image corresponding to the N-th frame F(N), displayed on the first display area A1 since the first light-emitting block BA1 is turned off.

As a result, the viewer may view a left eye frame corresponding to the (N−1)-th frame F(N−1) image during the second sub frame F(N−1)2 of the (N−1)-th frame and the first sub frame F(N)1 of the N-th frame.

Then, during a second sub frame F(N)2 of the N-th frame, the ((n/2)+1)-th to n-th gate signals G(n/2)+1, . . . , Gn are applied to the second display area A2 of the display panel 200. Therefore, the second display area A2 displays an image that changes from a left eye image corresponding to the (N−1)-th frame F(N−1) into a right eye image corresponding to the N-th frame F(N). At this time, the first display area A1 displays a right eye image F(N)_RI corresponding to the N-th frame.

The first light-emitting block BA1 emits the light in response to the first light-emitting control signal BLC1 having the high level, and the second light-emitting block BA2 is turned off in response to the second light-emitting control signal BLC2 having the low level.

The shutter device 600 closes the first shutter 613 in response to the first shutter control signal SHC1 having the low level, and opens the second shutter 623 in response to the second shutter control signal SHC2 having the high level. Therefore, the viewer may view a first right eye image F(N)_RI corresponding to the N-th frame displayed on the first display area A1. However, the viewer may not view the image, which changes from a left eye image corresponding to the (N−1)-th frame F(N−1) into a right eye image corresponding to the N-th frame F(N), displayed on the second display area A2 since the second light-emitting block BA2 is turned off.

During a first sub frame F(N+1)1 of the (N+1)-th frame, the first to (n/2)-th gate signals G1, . . . , Gn/2 are applied to the first display area A1. Therefore, the first display area A1 displays an image that changes from a right eye image corresponding to the N-th frame F(N) into a left eye image corresponding to the (N+1)-th frame F(N+1). At this time, the second display area A2 displays a right eye image F(N)_RI corresponding to the N-th frame.

The first light-emitting block BA1 is turned off in response to the first light-emitting control signal BLC1 having the low level, and the second light-emitting block BA2 emits the light in response to the second light-emitting control signal BLC2 having the high level.

The shutter device 600 closes the first shutter 613 in response to the first shutter control signal SHC1 having the low level, and opens the second shutter 623 in response to the second shutter control signal SHC2 having the high level. Therefore, the viewer may view a second right eye image F(N)_RI corresponding to the N-th frame displayed on the second display area A2. However, the viewer may not view the image, which changes from a right eye image corresponding to the N-th frame F(N) into a left eye image corresponding to the (N+1)-th frame F(N+1), displayed on the first display area A1 since the first light-emitting block BA1 is turned off.

As a result, the viewer may view the right eye frame image corresponding to the N-th frame F(N) during the second sub frame F(N)2 of the N-th frame and the first sub frame F(N+1)1 of the (N+1)-th frame.

Then, during a second sub frame F(N+1)2 of the (N+1)-th frame, the ((n/2)+1)-th to n-th gate signals G(n/2)+1, . . . , Gn are applied to the second display area A2 of the display panel 200. Therefore, the second display area A2 displays an image that changes from a right eye image corresponding to the N-th frame F(N) into a left eye image corresponding to the (N+1)-th frame F(N+1). At this time, the first display area A1 displays a left eye image F(N+1)_LI corresponding to the (N+1)-th frame.

The first light-emitting block BA1 emits light in response to the first light-emitting control signal BLC 1 having the high level and the second light-emitting block BA2 is turned off in response to the second light-emitting control signal BLC2 having the low level.

The shutter device 600 opens the first shutter 613 in response to the first shutter control signal SHC1 having the high level, and closes the second shutter 623 in response to the second shutter control signal SHC2 having the low level. Therefore, the viewer may view a first left eye image F(N+1)_LI corresponding to the (N+1)-th frame displayed on the first display area A1. However, the viewer may not view the image, which changes from a right eye image corresponding to the N-th frame F(N) into a left eye image corresponding to the (N+1)-th frame F(N+1), displayed on the second display area A2 since the second light-emitting block BA2 is turned off.

As described above, a light-emitting block corresponding to a display area displaying an image mixing the left eye image and the right eye image is turned off so that a viewing period during which the left eye frame image or the right eye frame image is viewed may be increased. Additionally, a driving frequency of the data driving part 300 need not be increased, and a normal frequency (e.g., 120 Hz) may be used as the driving frequency of the data driving part 300.

Hereinafter, the same reference numerals will be used to refer to the same or like parts as those described in the previous exemplary embodiments, and any repetitive detailed explanation will be omitted.

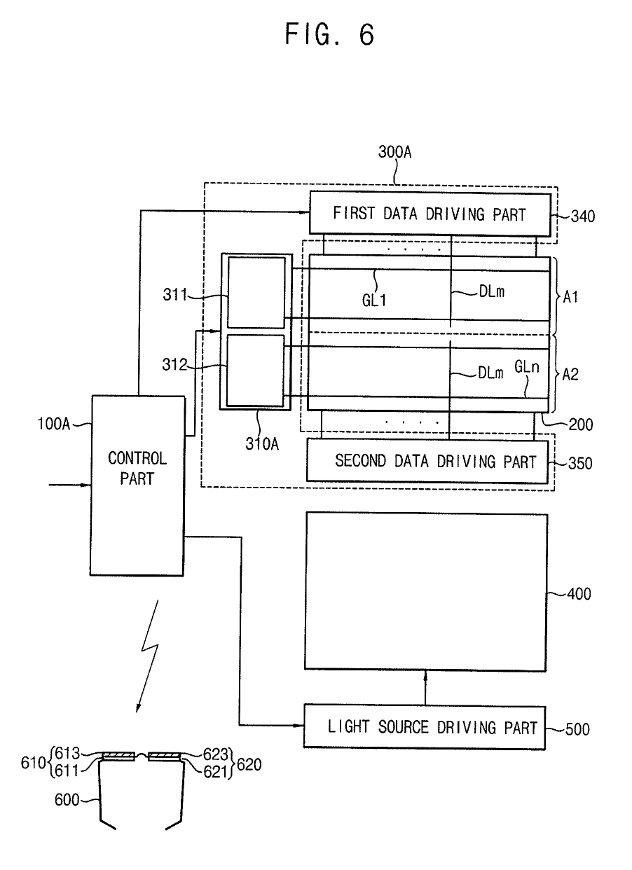

FIG. 6 is a block diagram illustrating a display apparatus according to an exemplary embodiment of the present invention. Referring to FIG. 6, the display apparatus includes a control part 100A, a display panel 200, a panel driving part 300A, a light source module 400, a light source driving part 500 and a shutter device 600.

The control part 100A controls an operation of the display apparatus based on a synchronized signal. The control part 100A provides a left eye image and a right eye image to the panel driving part 300A based on the synchronized signal and an image signal. The synchronized signal and the image signal may be provided from an external source. The control part 100A controls the shutter device 600 based on the image displayed on the display panel 200.

The panel driving part 300A includes a gate driving part 310A providing a gate signal to the gate line GL, and a first data driving part 340 and a second data driving part 350 providing a data voltage to the data line DL. For example, the gate driving part 310A includes a first gate circuit 311 and a second gate circuit 312. The first gate circuit 311 provides a plurality of gate signals to a first display area A1 of the display panel 200. The second gate circuit 312 provides a plurality of gate signals to a second display area A2 of the display panel 200. An m-th data line is divided in the first and second display areas A1 and A2 (e.g., m is a positive integer). For example, an m-th data line in the first display area A1 is separate and distinct from an m-th data line in the second display area A2. The first data driving part 340 is electrically connected to a data line disposed in the first display area A1, and applies the data voltage to the first display area A1 of the display panel 200. The second data driving part 350 is electrically connected to a data line disposed in the second display area A2 of the display panel 200, and applies the data voltage to the second display area A2 of the display panel 200.

The first and second data driving parts 340 and 350 display a frame image on the display panel 200 using a dual driving method. Thus, the first and second data driving parts 340 and 350 display the left eye frame image or the right eye frame image on the display panel 200 during about a half of the frame.

The light source module 400 provides the light to the display panel 200. The light source driving part 500 controls the light source module 400 so that the light source module 400 emits the light while an image is displayed on the display panel 200.

The shutter device 600 includes a left eye lens part 610 and a right eye lens part 620. The left eye lens part 610 includes a first lens 611 and a first shutter 613, and the right eye lens part 620 includes a second lens 621 and a second shutter 623. The shutter glass device may be an LC shutter glass including an LC shutter that opens or closes in accordance with an arrangement angle of the LC. The shutter device 600 opens the first shutter 613 and closes the second shutter 623 during about a half of the frame after the left eye frame image is displayed on the display panel 200 during about a half of the frame. Additionally, the shutter device 600 opens the second shutter 623 and closes the first shutter 613 during about a half of the frame after the right eye frame image is displayed on the display panel 200 during about a half of the frame. Therefore, the viewer may view the left eye frame image or the right eye frame image during about a half of the frame.

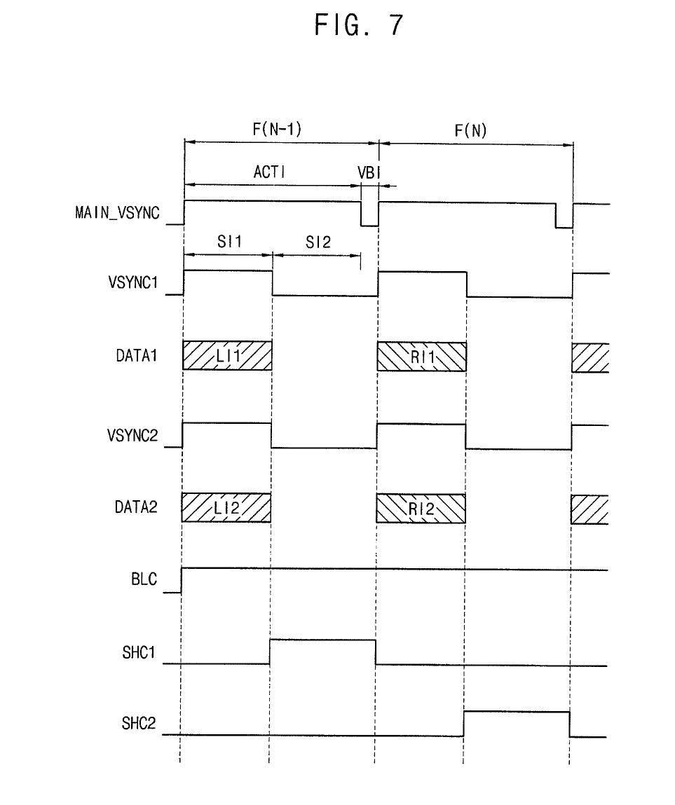

FIG. 7 is a timing diagram illustrating a method of displaying a stereoscopic image using the display apparatus of FIG. 6 according to an exemplary embodiment of the inventive concept.

Referring to FIGS. 6 and 7, the control part 100A generates a first vertically synchronized signal VSYNC1 and a second vertically synchronized signal VSYNC2 based on a main vertically synchronized signal MAIN_VSYNC. The main vertically synchronized signal MAIN_VSYNC may be received from an external source. The main vertically synchronized signal MAIN_VSYNC includes a reference active period ACTI and a reference blanking period VBI, and has a cycle of a single frame. The control part 100A generates a first vertically synchronized signal VSYNC1 and a second vertically synchronized signal VSYNC2 based on an (N−1)-th main vertically synchronized signal during an (N−1)-th frame F(N−1), and generates the first vertically synchronized signal VSYNC1 and the second vertically synchronized signal VSYNC2 based on the (N−1)-th main vertically synchronized signal during the N-th frame F(N) (wherein ‘N’ is a positive integer).

Each of the first and second vertically synchronized signals VSYNC1 and VSYNC2 includes a sub active period and a sub blanking period. The sub active period corresponds to about a first half of the reference active period ACTI (e.g., a first sub period SI1), and the sub blanking period corresponds to about a second half of the reference active period ACTI (e.g., second sub period SI2) and the reference blanking period VBI.

The control part 100A divides frame image data into first image data DATA1 and second image data DATA2. The first image data DATA1 corresponds to the first display area A1 of the display panel 200, and the second image data DATA2 corresponds to the second display area A2 of the display panel 200. The control part 100A provides the first image data DATA1 to the first data driving part 340 based on the first vertically synchronized signal VSYNC1. The first data driving part 340 provides the first image data DATA1 to the first display area A1 of the display panel 200 during the first sub period SI1. Additionally, the control part 100A provides the second image data DATA2 to the second data driving part 350 based on the second vertically synchronized signal VSYNC2. The second data driving part 350 provides the second image data DATA2 to the second display area A2 of the display panel 200 during the first sub period SI1. The gate driving part 310A provides the gate signals to the display panel 200 during the first sub period SI1.

The control part 100A controls the shutter device 600 to selectively open the first shutter 613 and the second shutter 623 during the second sub period SI2. Therefore, the viewer may view the left eye frame image or the right eye frame image displayed on the display panel 200 during the second sub period SI2.

Hereafter, referring to FIGS. 6 and 7, a method of displaying stereoscopic image will be explained according to an exemplary embodiment of the invention.

The control part 100A controls the light source driving part 500 so that the light source driving part 500 drives the light source module 400 when the display panel 200 is driven. The light source module 400 emits the light in response to a light-emitting control signal BLC having a high level.

During the (N−1)-th frame F(N−1), the control part 100A generates the first vertically synchronized signal VSYNC1 and the second vertically synchronized signal VSYNC1 based on the (N−1)-th main vertically synchronized signal. The control part 100A divides the left eye frame image into a first left eye image LI1 corresponding to the first display area A1 and a second left eye image LI2 corresponding to the second display area A2. The control part 100A provides the first and second left eye images LI1 and LI2 to the first and second data driving parts 340 and 350, respectively.

The first data driving part 340 provides the first left eye image LI1 to the first display area A1 during the sub active period of the first vertically synchronized signal VSYNC1. The sub active period is a first sub period SI1 corresponding to about a half of the reference active period ACTI. The first gate circuit 311 provides the gate signals to the first display area A1 during the first sub period SI1. The second data driving part 350 provides the second left eye image LI2 to the second display area A2 during the sub active period of the second vertically synchronized signal VSYNC2. The sub active period is the first sub period SI1 corresponding to about a half of the reference active period ACTI. The second gate circuit 312 provides the gate signals to the second display area A2 during the first sub period SI1. Therefore, the display panel 200 displays the left eye frame image during the first sub period SI1.

Then, during a sub blanking period (e.g., a second sub period SI2 of the reference active period ACTI and the reference blanking period VBI), the display panel 200 maintains the left eye frame image displayed on the display panel 200. The sub blanking period of the first or second vertically synchronized signal VSYNC1 or VSYNC2 may include the second sub period SI2 and the reference blanking period VBI.

When the left eye frame image displayed on the display panel 200 is maintained during the second sub period SI2 and the reference blanking period VBI, the shutter device 600 opens the first shutter 613 in response to a first shutter control signal SHC1 having a high level and closes the second shutter 623 in response to a second shutter control signal SHC2 having a low level. Therefore, the viewer may view the left eye frame image displayed on the display panel 200 during the second sub period SI2 and the reference blanking period VBI.

During the Nth frame F(N), the control part 100A generates the first vertically synchronized signal VSYNC1 and the second vertically synchronized signal VSYNC1 based on the N-th main vertically synchronized signal. The control part 100A divides the right eye frame image into a first right eye image RI1 corresponding to the first display area A1 and a second right eye image RI2 corresponding to the second display area A2. The control part 100A provides the first and second right eye images RI1 and RI2 to the first and second data driving parts 340 and 350, respectively.

The first data driving part 340 provides the first right eye image RI1 to the first display area A1 during the sub active period of the first vertically synchronized signal VSYNC1. The sub active period is a first sub period SI1 corresponding to about a half of the reference active period ACTI. The first gate circuit 311 provides the gate signals to the first display area A1 during the first sub period SI1. The second data driving part 350 provides the second right eye image RI2 to the second display area A2 during the sub active period of the second vertically synchronized signal VSYNC2. The sub active period is the first sub period SI1 corresponding to about a half of the reference active period ACTI. The second gate circuit 312 provides the gate signals to the second display area A2 during the first sub period SI1. Therefore, the display panel 200 displays the right eye frame image during the first sub period SI1.

Then, during a second sub period SI2 of the reference active period ACTI and the reference blanking period VBI, the display panel 200 maintains the right eye frame image displayed on the display panel 200. The sub blanking period of the first or second vertically synchronized signal VSYNC1 or VSYNC2 may include the second sub period SI2 and the reference blanking period VBI.

When the right eye frame image displayed on the display panel 200 is maintained during the second sub period SI2 and the reference blanking period VBI, the shutter device 600 closes the first shutter 613 in response to a first shutter control signal SHC1 having a low level and opens the second shutter 623 in response to a second shutter control signal SHC2 having a high level. Therefore, the viewer may view the right eye frame image displayed on the display panel 200 during the second sub period SI2 and the reference blanking period VBI.

As described above, the viewer may view the left eye frame image or the right eye frame image during about a half of the frame. According to at least one embodiment of the present invention, stereoscopic images are displayed using the dual driving method so that a viewing period during which the left eye frame image or the right eye frame image is viewed may be increased. Additionally, a driving frequency of the data driving part need not be increased, and a normal frequency (e.g., 120 Hz) may be used as the driving frequency. However, embodiments of the invention are not limited to a normal frequency of 120 Hz, as other driving frequencies may be used.

As described above, according to at least one embodiment of the present invention, a light-emitting block corresponding to a display area displaying an image mixing the left eye image and the right eye image is turned off so that a viewing period during which the left eye frame image or the right eye frame image is viewed may be increased.

Additionally, according to at least one embodiment of the present invention, stereoscopic images are displayed using a dual driving method so that a viewing period during which the left eye frame image or the right eye frame image is viewed may be increased.

While states of the above-described methods are described and illustrated as using particular high and low levels of the control signals BLC1, BLC2, SHC1, and SHC2, embodiments of the present invention are not limited thereto. For example, if the control signals were all toggled, the above methods would open and close shutters, and apply right and left images in the same manner, but in response to toggled portions of the control signals.

Having described exemplary embodiments of the present invention, it should be understood that various changes and modifications can be made in the exemplary embodiments without departing from the present invention. Accordingly, all such modifications are intended to be included within the scope of the disclosure

What is claimed is:

1. A method of displaying a stereoscopic image, the method comprising:
providing light to a first display area of a display panel during a second sub frame of an (N−1)-th frame, the first display area displaying a first left eye image during a first sub frame of the (N−1)-th frame prior to the second sub frame of the (N−1)-th frame panel, wherein ‘N’ is a positive integer;
providing the light to a second display area of the display panel during a first sub frame of an N-th frame, the second display area displaying a second left eye image during the second sub frame of the (N−1)-th frame prior to the first sub frame of the N-th frame;
providing the light to the first display area of the display panel during a second sub frame of the N-th frame, the first display area displaying a first right eye image during the first sub frame of the N-th frame prior to the second sub frame of the N-th frame; and
providing the light to the second display area of the display panel during a first sub frame of an (N+1)-th frame, the second display area displaying a second right eye image during the second sub frame of the N-th frame prior to the first sub frame of the (N+1)-th frame.

2. The method of claim 1, further comprising:
opening a first shutter of a shutter device and closing a second shutter of the shutter device during the second sub frame of the (N−1)-th frame and the first sub frame of the N-th frame; and
closing the first shutter of the shutter device and opening the second shutter of the shutter device during the second sub frame of the N-th frame and the first sub frame of the (N+1)-th frame.

3. The method of claim 1, wherein providing the light to the first display area comprises blocking the light provided to the second display area, and providing the light to the second display area comprises blocking the light provided to the first display area.

4. The method of claim 1, wherein each of the first and second sub frames corresponds to about a half of the frame.

5. A method of displaying a stereoscopic image, the method comprising:
displaying a first left eye image on a first display area of a display panel and a second left eye image on a second display area of the display panel during a first sub period within a reference active period of an (N−1)-th main vertically synchronized signal, wherein ‘N’ is a positive integer);
maintaining the first and second left images displayed on the display panel during a second sub period within the reference active period of the (N−1)-th main vertically synchronized signal;
displaying a first right eye image on the first display area and a second right eye image on the second display area during a first sub period within a reference active period of an N-th main vertically synchronized signal; and
maintaining the first and second right images displayed on the display panel during a second sub period within the reference active period of the N-th main vertically synchronized signal.

6. The method of claim 5, further comprising:
opening a first shutter of a shutter device and closing a second shutter of the shutter device while the first and second left eye images are displayed on the display panel; and
opening the second shutter of the shutter device and closing the first shutter of the shutter device while the first and second right eye images are displayed on the display panel.

7. The method of claim 5, wherein each of the (N−1)-th and N-th main vertically synchronized signals includes a reference blanking period, and an image displayed on the display panel during the reference active period is maintained during the reference blanking period.

8. The method of claim 5, wherein each of the first and second sub periods corresponds to about a half of the reference active period.

9. A display apparatus comprising:
a display panel periodically displaying a left eye frame image and a right eye frame image;
a light source module including a first light-emitting block and a second light-emitting block, the first light-emitting block providing light to a first display area of the display panel when a first left eye image or a first right eye image is displayed on the first display area, the second light-emitting block providing the light to a second display area of the display panel when a second left eye image or a second right eye image is displayed on the second display area; and
a shutter device including a first shutter and a second shutter, wherein the first shutter is open when the left eye frame image is displayed on the display panel, the second shutter is open when the right eye frame image is displayed on the display panel.

10. The display apparatus of claim 9, wherein the first light-emitting block provides the light to the first display area during a second sub frame of an (N−1)-th frame, and the first left eye image is displayed on the first display area during a first sub frame of the (N−1)-th frame prior to the second sub frame of the (N−1)-th frame, wherein ‘N’ is a positive integer, and
wherein the second emitting block provides the light to a second display area during a first sub frame of an N-th frame, and the second left eye image is displayed on the second display area during the second sub frame of the (N−1)-th frame prior to the first sub frame of the N-th frame.

11. The display apparatus of claim 10, wherein the shutter device opens the first shutter and closes the second shutter during the second sub frame of the (N−1)-th frame and the first sub frame of the N-th frame.

12. The display apparatus of claim 10, wherein the first light-emitting block provides the light to the first display area during the second sub frame of the N-th frame, and the first right eye image is displayed on the first display area during the first sub frame of the N-th frame prior to the second sub frame of the N-th frame, and
wherein the second light-emitting block provides the light to the second display area during a first sub frame of an (N+1)-th frame, and the second right eye image is displayed on the second display area during the second sub frame of the N-th frame prior to the first sub frame of the (N+1)-th frame.

13. The display apparatus of claim 12, wherein the shutter device closes the first shutter and opens the second shutter during the second sub frame of the N-th frame and the first sub frame of the (N+1)-th frame.

14. The display apparatus of claim 9, wherein the second light-emitting block is turned off when the first light-emitting block emits the light, and
the second light-emitting block emits the light when the first light-emitting block is turned off.

15. The display apparatus of claim 9, wherein each of the first and second sub frames corresponds to about a half of the frame.

16. A display apparatus comprising:
a display panel periodically displaying a left eye frame image and a right eye frame image;
a first data driving part providing a first left eye image or a first right eye image to a first display area of the display panel during a first sub period within a reference active period of a main vertically synchronized signal;
a second data driving part providing a second left eye image or a second right eye image to a second display area of the display panel during the first sub period; and
a shutter device including a first shutter and a second shutter, and selectively opening the first shutter and the second shutter according to the left eye frame image or the right eye frame image displayed on the display panel during a second sub period within the reference active period.

17. The display apparatus of claim 16, wherein the display panel displays the first left eye image on the first display area and the second left eye image on the second display area during the first sub period within the reference active period of an (N−1)-th main vertically synchronized signal, wherein ‘N’ is a positive integer, and
the display panel maintains the first and second left eye images displayed on the display panel during the second sub period within the reference active period of the (N−1)-th main vertically synchronized signal.

18. The display apparatus of claim 17, wherein the display panel displays the first right eye image on the first display area and the second right eye image on the second display area during the first sub period within the reference active period of the N-th main vertically synchronized signal, and
the display panel maintains the first and second right eye images displayed on the display panel during the second sub period within the reference active period of the N-th main vertically synchronized signal.

19. The display apparatus of claim 18, wherein each of the (N−1)-th and N-th main vertically synchronized signals includes a reference blanking period, and an image displayed on the display panel during the reference active period is maintained during the reference blanking period.

20. The display apparatus of claim 18, wherein each of the first and second sub periods corresponds to about a half of the reference active period.
